(19) United States
(12) Patent Application Publication
(10) Pub. No.: US 2020/0260753 A1
(43) Pub. Date: Aug. 20, 2020

(54) Process for Manufacture of Process Cheese Without Emulsifying Salt

(71) Applicant: South Dakota Board of Regents, Brookings, SD (US)

(72) Inventors: Lloyd E. Metzger, Bruce, SD (US); Ahmed Hammam, Brookings, SD (US)

(21) Appl. No.: 16/793,818

(22) Filed: Feb. 18, 2020

Related U.S. Application Data
(60) Provisional application No. 62/807,527, filed on Feb. 19, 2019.

(51) Int. Cl. A23C 19/08

(52) U.S. Cl. CPC A23C 19/08; A23C 2250/054

(57) ABSTRACT

A process cheese produced by a combination of an acid curd and a concentrated milk protein at specific ratios is disclosed. The process cheese is produced without an emulsifying salt. A method of producing the process cheese is disclosed. The method includes preparing a volume of concentrated milk protein and a volume of acid curd. The method further includes producing a volume of process cheese product by combining the volume of the concentrated milk protein and the volume of acid curd. The ratio of protein in the acid curd to the protein in the concentrated milk protein ranges from 1.35:1 to 3.35:1.

### CROSS-REFERENCE TO RELATED APPLICATIONS

The present application claims the benefit under 35 U.S.C. § 119(e) of U.S. Provisional Application Ser. No. 62/807,527, filed Feb. 19, 2019, which is hereby incorporated by reference in its entirety.

### TECHNICAL FIELD

The present invention generally relates to a method of producing process cheese, and, more particularly, to a method of producing process cheese without emulsifying salts.

### BACKGROUND

Process cheese traditionally utilizes natural cheese, emulsifying salts, and other dairy and non-dairy ingredients. The process cheese is produced by heating and mixing the various ingredients to form a homogenous product that has distinct functional characteristics (e.g., melt without fat separation) and an extended shelf-life. Emulsifying salts (e.g., sodium citrate, disodium phosphate, and the like) play a critical role in determining the functional and physical characteristics of process cheese by improving the emulsification characteristic of casein by displacing the calcium-phosphate complexes that are present in the insoluble calcium-paracaseinate-phosphate network within the natural cheese. The displacement of calcium phosphate complexes disrupts the major molecular force that cross-links the monomers of casein in the network. This disruption, in conjunction with heating and mixing, leads to hydration and partial dispersion of the calcium-paracaseinate phosphate network. In addition to increased hydration, the partially dispersed calcium-paracaseinate complex also has improved fat binding characteristics and forms a homogenous emulsion that is typical of process cheese. However, despite the functional advantages of emulsifying salts, there is a negative consumer perception of emulsifying salts. Thus, it is desirable to provide a method and product that avoids the shortcomings of conventional approaches.

### SUMMARY

A process cheese is disclosed, in accordance with one or more embodiments of the present disclosure. In some embodiments, the process cheese includes an acid curd. In some embodiments, the process cheese further includes a concentrated milk protein. In some embodiments, the ratio of protein in the acid curd to the protein in the concentrated milk protein ranges from 1.35:1 and 3.35:1.

A method of producing process cheese is disclosed in accordance with one or more embodiments of the present disclosure. In some embodiments, the method includes the step of preparing a volume of concentrated milk protein. In some embodiments, the method further includes the step of preparing a volume of acid curd. In some embodiments, the method further includes the step of producing a volume of process cheese product. In some embodiments, the step of producing a volume of process cheese product includes combining the volume of the concentrated milk protein with the volume of acid curd. In some embodiments, the ratio of protein in the acid curd to the protein in the concentrated milk protein ranges from 1.35:1 and 3.35:1.

A process cheese is disclosed in accordance with one or more embodiments of the present disclosure. In some embodiments, the process cheese is produced by a step of preparing a volume of acid curd. In some embodiments, the process cheese is produced by a further step of preparing a volume of concentrated milk protein. In some embodiments, the process cheese is produced by a further step of producing a volume of process cheese product by combining the volume of the concentrated milk protein with the volume of the acid curd, wherein a ratio of protein in the acid curd to protein in the concentrated milk protein ranges from 1.35:1 and 3.35:1.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1 illustrates a system for producing process cheese, in accordance with some embodiments of the present disclosure.

FIG. 2 illustrates a flowchart of a method for producing process cheese in accordance with some embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Accordingly, embodiments of the present disclosure are directed to a process cheese and a method for producing process cheese produced through a combination of a concentrated milk protein with an acid curd at specific ratios to produce process cheese. It is contemplated herein that embodiments of the present disclosure may produce a clean label process cheese with required emulsion capacity which does not contain emulsifying salts. Additionally, the system and method of the present disclosure may provide a number of advantages over previous approaches. By way of example, by utilizing concentrated milk protein, manufacturing costs may be reduced, while simultaneously improving the functionality of the product process cheese.

In some embodiments, the process cheese includes an acid curd. In some embodiments, the acid curd used in the production of the process cheese is produced from at least one of a concentrated milk protein (e.g., liquid or powder) or other milk product (e.g., a skim milk). For example, the concentrated milk protein used to produce the acid curd may be a liquid concentrate that has been diluted with water to have a protein concentrate of 3%. For example, the concentrated milk protein used to produce the acid curd may be a liquid concentrate that has been diluted with water to have a protein concentrate of 9%.

It should be known that concentrated milk protein includes both milk protein concentrate, a product with a casein-to-whey protein ratio equivalent to that of the original milk (e.g., approximately 80:20) and micellar casein, also referred to as micellar casein concentrate (MCC), a product with a casein-to-whey protein ratio that ranges from approximately 82:18 to 95:5. Therefore a concentrated milk protein may refer to a milk protein concentrate, a micellar casein concentrate, or both. Conversely, milk protein concentrate and micellar casein concentrate both refer to a concentrated milk protein.

In some embodiments, the production of the acid curd used in the production of process cheese is produced from the same concentrated milk protein that is later used to combine with the acid curd to produce the process cheese. For example, a concentrated milk protein may be used in producing an acid curd (e.g., a cottage cheese). Then, in a subsequent step, more concentrated milk protein from the same source or lot used to make the acid curd is then combined with the acid curd for the production of the process cheese. In this manner, the acid curd and concentrated milk protein of the process cheese come from the same source.

In some embodiments, the acid curd used in the production of the process cheese is a cottage cheese. Other types of acid cheese products may be used in the production of the process cheese. For example, the acid curd may be a skim milk product. In another example, the acid curd may be Ricotta cheese. In another example, the acid curd may be a Quarg cheese. In another example, the acid curd may be a Fromage frais.

In some embodiments, the process cheese includes a concentrated milk protein. In some embodiments, the concentrated milk protein is a milk protein concentrate. In some embodiments, the concentrated milk protein is a micellar casein concentrate. In some embodiments, the micellar casein concentrate may include a dairy product (e.g., a skim milk).

In some embodiments, the micellar casein concentrate is reduced in at least one of calcium or phosphorous, or both calcium and phosphorous. A micellar casein concentrate reduced in both calcium and phosphorous is disclosed in U.S. patent application Ser. No. 15/775,762 entitled METHOD AND SYSTEM FOR MANUFACTURING MINERAL-REDUCED MICELLAR CASEIN CONCENTRATE, filed on May 11, 2018, which is incorporated herein by reference in the entirety. Micellar casein concentrate reduced in calcium and phosphorous promotes emulsification through the rearrangement of micelle structure. It should be known that the micellar casein concentrate may be reduced in other minerals besides calcium and phosphorous production of process cheese (e.g., sodium). Therefore, the above description should not be interpreted as a limitation of the present limitation, but merely as an illustration.

In some embodiments, the process cheese includes a combination of acid curd and concentrated milk protein, wherein the ratio of the protein from the acid curd to the protein from the concentrated milk protein ranges from 1.35:1 to 3.35:1. That is, the percentage of acid curd protein may range from 57.4% to 77.0%, with the percentage of protein from concentrated milk protein ranging from 23.0% to 42.6%. This ratio produces a process cheese with the ideal pH and emulsification characteristics without the use of emulsifying salt. In some embodiments, the process cheese includes a combination of acid curd and concentrated milk protein, wherein the ratio of the protein from the acid curd to the protein from the concentrated milk protein ranges from 1.40:1 to 3.0:1. That is, the percentage of acid curd protein may range from 58.3% to 75.0%, with the percentage of protein from the concentrated milk protein ranging from 25.0% to 41.7%. In some embodiments, the process cheese includes a combination of acid curd and concentrated milk protein, wherein the ratio of the protein from the acid curd to the protein from the concentrated milk protein ranges from 1.45:1 to 2.75:1. That is, the percentage of acid curd protein may range from 59.2% to 73.3%, with the percentage of protein from the concentrated milk protein varying from 26.7% to 40.8%. In some embodiments, the process cheese includes a combination of acid curd and concentrated milk protein, wherein the ratio of the protein from the acid curd to the protein from the concentrated milk protein ranges from 1.5:1 to 2.5:1. That is, the percentage of acid curd protein may range from 60% to 71.4%, with the percentage of protein from the concentrated milk protein ranging from 28.6% to 40%. In some embodiments, the ratio of the protein from the acid curd to the protein from the concentrated milk protein ranges from 1.75:1 to 2.25:1. That is, the percentage of acid curd protein may range from 63.6% to 69.2%, with the percentage of protein from the concentrated milk protein ranging from 30.8% to 36.4%. In some embodiments, the ratio of the protein from the acid curd to the protein from the concentrated milk protein is approximately 2:1 (e.g., approximately 66.7% of the protein is acid curd protein, and approximately 33.3%. of the protein is protein from the concentrated milk protein. It should be noted that the ratio of the protein in the acid curd to the protein in the concentrated milk protein in this disclosure refers to protein mass. For example, for a 2:1 ratio of acid curd protein to protein from concentrated milk protein in a 100 gram amount of total protein (e.g., all water and other nonprotein components removed) the total acid curd protein and concentrated milk protein protein mass would contain approximately 66.6 grams of acid curd protein and 33.3 grams of concentrated milk protein, respectively.

In some embodiments, the process cheese is produced without using emulsifying salts (i.e., emulsifying salts used at a concentration to readily emulsify the dairy product) For example, the process cheese may not contain a emulsifying salt (e.g., disodium phosphate) at a concentration that would produce an emulsifying activity (e.g., ˜2% by weight). It should be known that the process cheese may have small amounts of emulsifying salt carried over from upstream processes which do not have a substantial effect on emulsification. It should also be known that the process cheese may have small amounts of salt (e.g., nonemulsifying salt) added for taste at concentrations that do not have a substantial effect on emulsification.

In some embodiments, additional dairy and non-dairy ingredients may be utilized in the formulation. Additional dairy and non-dairy ingredients may include, but are not limited to, rennet-curd cheese, a ripened cheese, a fresh cheese, a whey, a deproteinized whey, non-emulsifying salts, a butter, or a butter oil, and other flavors. For example, cheddar cheese, a type of rennet-curd cheese, may be an additional dairy ingredient to the process cheese. In another example, mozzarella cheese, another type of rennet-curd cheese, may be an additional dairy ingredient to the process cheese.

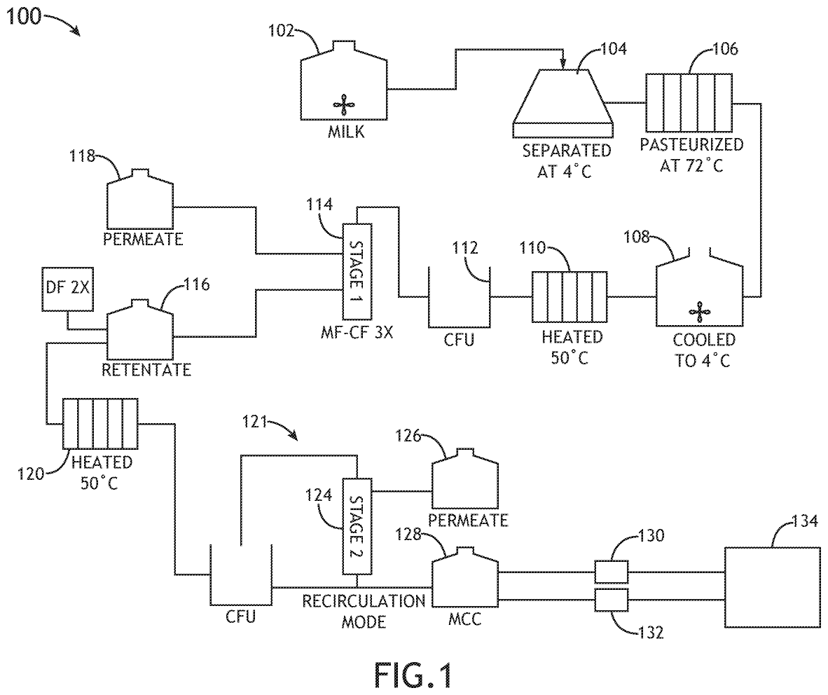

FIG. 1 illustrates a system 100 for producing process cheese without emulsifying salts, in accordance with some embodiments of the present disclosure. System 100 may include, but is not limited to, centrifuge 104, a heat exchanger 106, a cooling tank 108, a ceramic filtration unit (CFU) 112, a micro-filtration unit 114, a ceramic filtration unit (CFU) 122, a microfiltration unit 124, a spray dryer 130, an acid curd tank 132, and a process cheese mixing unit 134. The system 100 comprises equipment known in the art for producing process cheese. Different components for process cheese production may be added or substituted within the system. Therefore, the above description should not be interpreted as a limitation of the present disclosure, but merely as an illustration.

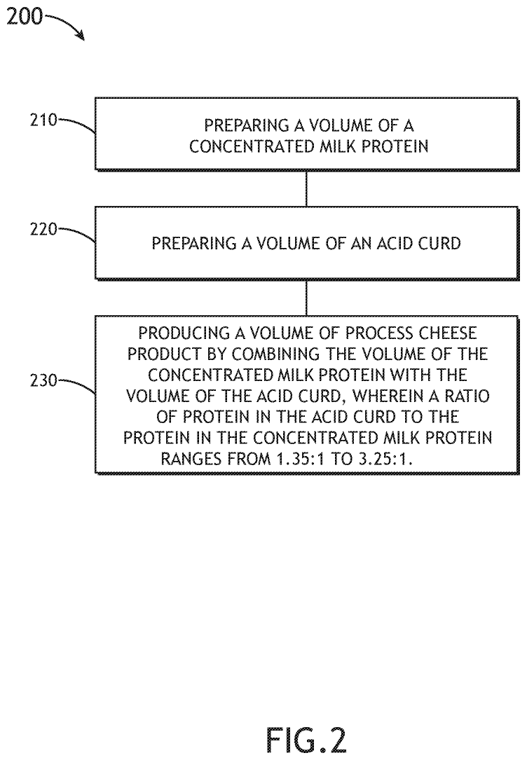

FIG. 2 illustrates a flowchart of a method 200 for producing process cheese without emulsifying salts, in accordance with some embodiments of the present disclosure. It is noted herein that the steps of method 200 may be implemented all or in part by system 100. It is further recognized, however, that the method 200 is not limited to the system 100 in that additional or alternative system-level embodiments may carry out all or part of the steps of method 200.

It is further noted herein that tests for producing process cheese without emulsifying salts were performed at a reduced scale. In this regard, various steps of method 200 may be shown and described in terms of volumes, times, temperatures, and masses used in the reduced-scale tests. It is further contemplated, however, that concepts, ratios, and recipes used in the test runs illustrated in method 200 may be applied to produce process cheese without emulsifying salts on a larger scale.

In some embodiments, the method 200 includes step 210 of preparing a concentrated milk protein. For example, the concentrated milk protein may be a milk product concentrate. In another example, the concentrated milk protein may be prepared as a micellar casein concentrate via the test run disclosed herein. In this test run, 750 kg of bovine whole milk was provided to a centrifuge 104 from a whole milk tank 102. The whole milk was then separated in the centrifuge 104 (Model MSE 140-48-177 Air Tight centrifuge, GEA Co., Oelde, Germany) at 4° C., producing a volume of skim milk. The centrifuge 104 may include any centrifuge 104 known in the art including, but not limited to, a centrifuge manufactured by GEA Co., of Oelde, Germany, Model MSE 140-48-177 Air Tight. Subsequently, the skim milk was pasteurized at 76° C. for sixteen seconds in a plate heat exchanger (e.g., heat exchanger 106). Similarly, it is noted herein that the skim milk from centrifuge 104 may be pasteurized by any heat exchanger or other equipment known in the art. For example, the heat exchanger 106 may include, but is not limited to, a heat exchanger model PRO2-SH, produced by AGC Engineering, of Bristow, Va.

After pasteurization, a volume of skim milk is cooled. For example, the volume of skim milk may be directed from the heat exchanger 106 to a cooling tank 108. In the test run, the pasteurized skim milk was kept at or below 4° C. until the processing of the process cheese. After cooling down, a first filtration process was performed on the volume of skim milk to produce a volume of retentate. For example, as shown in FIG. 1, a micro-filtration-GP sub-system 111 (MF GP sub-system 111) may include a ceramic filtration unit 112 and a micro-filtration unit 114. The MF GP sub-system 111 may be used to generate volumes of retentate and permeate, which may be directed to retentate tank 116 and a permeate tank 118, respectively (Stage 1). During the test run, the micro-filtration unit 114 was started with soft water at 50° C., and was then subsequently transitioned from water to skim milk. The skim milk was then directed from the cooling tank 108 to a heat exchanger 110, where the skim milk was heated to 50° C. The heat exchanger 110 may include any heat exchanger or heating equipment known in the art including, but not limited to, a SABCO Plate-pro Sanitary Chiller NP925-41.

Following the heat exchanger 110, pre-heated skim milk was run through a ceramic filtration unit 112 (CFU 112) via a feed pump. In one test run, the CFU 112 was equipped with ceramic Membralox GP membranes. Here, membranes exhibited a pore diameter of 0.1 μm, a surface area of 1.68 m², and a membrane length of 1.02 m. Furthermore, CFU 112 included seven ceramic tubes vertically mounted within the system, where each ceramic tube included nineteen channels with a 3.3 mm diameter. Pre-heated and filtered skim milk was then provided to the micro-filtration unit 114 operating with soft water at 50° C. In one embodiment, the micro-filtration unit 114 is operated in a constant flux mode using a three-times concentration factor (3×CF) (1-part retentate: 2-parts permeate) in a feed and bleed mode at 50° C. For example, during one test run, approximately 730 kg of skim milk was provided from the CFU 112 to the micro-filtration unit 114 via a feed pump. In some embodiments, water used within the micro-filtration unit 114 during the start-up procedure may be flushed out as the skim milk is provided to the micro-filtration unit 114 during a transition period. For example, during a filtration run, the water was used during the start-up procedure and was flushed out with skim milk by collecting approximately 37 kg. of permeate and 18 kg of retentate in containers, which were then discarded. During this transition period, the permeate flow rate was approximately 120 L/hr (71.42 L/M²/hr flux) and the retentate flow rate was approximately 60 L/hr. In one embodiment, the GP MF sub-system may include a feed pump and/or a retentate recirculation pump.

Following the start-up procedure and transition period, retentate and permeate produced within the micro-filtration unit 114 may be collected in the retentate tank 116 and the permeate tank 118, respectively. For example, during one test run, volumes of retentate and permeate were collected, and their weights were recorded continuously. During micro-filtration with the micro-filtration unit 114, the following operating conditions were applied: Rpᵢ=400 kPa, Rp₀=200 kPa, and Pp₀=200 kPa. The concentration factor within the micro-filtration unit 114 may be monitored at regular or irregular intervals (e.g., every fifteen minutes, and the like) by collecting and weighing permeate and retentate samples. For example, in order to monitor composition and the concentration factor, the composition of permeate samples and retentate samples may be examined using an infrared spectrophotometer, such as the MilkoScan FT1-Lactoscope FTIR, provided by FOSS Instruments Analytical A/S of Hillerod, Denmark.

In these test runs, the average processing time for the first stage (e.g., production of a volume of retentate) was approximately 240 minutes. In embodiments, the volume of retentate stored in retentate tank 116, is maintained at or below 4° C. In another embodiment, following the production of the volume of retentate, the CFU 112 and the micro-filtration unit may be cleaned using caustic acid solutions.

After the volume of retentate is produced, the volume of retentate is then diluted to produce a volume of diluted retentate mixture. For example, as shown in FIG. 1, the volume of retentate within the retentate tank 116 may be diluted with soft water to obtain a diafiltration factor (DF) of two (2×). For instance, 240 kg of retentate within the retentate tank 116 may be diluted with 480 kg of water to obtain a DF of 2×. The diluted retentate mixture may then be mixed. In this regard, the retentate tank 116 may include one or more mixing structures configured to thoroughly mix the diluted retentate mixture.

In some embodiments, an additional filtration process is performed on the volume of diluted retentate mixture to produce a volume of liquid micellar casein concentrate. For example, the volume of diluted retentate mixture may be directed from the retentate tank 116 to a heat exchanger 120. The heat exchanger 120 may be configured to pre-heat the volume of diluted retentate mixture to approximately 50° C. The pre-heated volume of diluted retentate mixture may then be provided to a MF GP sub-system 121 including a CFU 122 and a micro-filtration unit 124 (Stage 2). It is noted herein that the MF GP sub-system 121 may comprise the same MF GP sub-system 111. In an additional and/or alternative embodiment, the MF GP sub-system 121 comprises a separate MF GP sub-system 121.

During operation, the MF GP sub-system 121 may be configured to operate in a 3× recirculation mode. During micro-filtration with the micro-filtration unit 124, the following conditions were applied: Rpᵢ=400 kPa, Rp₀=200 kPa, and Pp₀=200 kPa. In one embodiment, the Pp₀ is decreased gradually due to decreasing serum protein removal in the retentate during the recirculation mode until 0 kPa is reached. In embodiments, permeate from the MF GP sub-system 121 is collected in a permeate tank 126, and a volume of liquid micellar casein concentrate (MCC retentate) is collected in an MCC tank 128. During one test run, the micro-filtration with the MF GP sub-system 121 was stopped when the composition of the liquid MCC retentate collected in the MCC tank 128 reached approximately 13% solids and approximately 9% protein. In one embodiment, the volume of liquid micellar casein concentrate may be cooled to approximately 4° C.

For example, during the test run, the MF GP sub-system 121 may be configured to operate in a 3× recirculation mode. During micro-filtration with the micro-filtration unit 124, the following conditions were applied: Rpᵢ=400 kPa, Rp₀=200 kPa, and Pp₀=200 kPa. In one embodiment, the Pp₀ is decreased gradually due to decreasing serum protein removal in the retentate during the recirculation mode until 0 kPa is reached. In embodiments, permeate from the MF GP sub-system 121 is collected in a permeate tank 126, and a volume of liquid micellar casein concentrate (MCC retentate) is collected in an MCC tank 128. During one test run, the micro-filtration with the MF GP sub-system 121 was stopped when the composition of the liquid MCC retentate collected in the MCC tank 128 reached approximately 13% solids and approximately 9% protein. In one embodiment, the volume of liquid micellar casein concentrate may be cooled to approximately 4° C.

In some embodiments, a volume of micellar casein concentrate powder is produced using at least a portion of the liquid MCC. For example, during one test run, a first sub-set of liquid MCC was separated and frozen for further analysis. A second sub-set of liquid MCC (composition 13.79% total solids and 9.54% protein) was evaporated and spray dried to produce a volume of micellar casein concentrate powder. For instance, as shown in FIG. 1, a second sub-set of liquid micellar casein concentrate was directed from the MCC tank to a spray dryer 130. The spray dryer 130 may include any spray dryer known in the art including, but not limited to, Niro-dryer ASO 412E, produced by Niro, Inc., of Columbia, Md. During the drying process, the drying inlet air temperature of the spray dryer 130 was maintained at approximately 190° C., and the outlet temperature of the spray dryer 130 was maintained at approximately 90° C. A volume of micellar casein concentrate powder with a composition of approximately 97.23% total solids and 65.38% protein was then collected from the spray dryer 130.

In some embodiments, the micellar casein concentrate may be a commercially available micellar casein concentrate. For example, the micellar casein concentrate may be a commercially available liquid micellar concentrate. In another example, the micellar casein concentrate may be a commercially available micellar casein concentrate powder.

In some embodiments, the method 200 includes step 220 of preparing a volume of acid curd. For example, the volume of acid curd may be produced from at least a portion of the volume of concentrated milk protein (i.e., micellar casein concentrate) produced in step 210. For instance, as shown in FIG. 1, at least a portion of the volume of liquid micellar casein concentrate from the MCC tank 128 may be directed to an acid curd tank 132 (e.g., during one test run, the third sub-set of liquid micellar casein concentrate was used to produce acid curd). In order to test varying compositions, the third sub-set of liquid micellar casein concentrate was divided into three separate containers during the test run, such that the first container included a first volume of liquid micellar casein concentrate, the second container included a second volume of liquid micellar cansein concentrate, and the third container included a third volume of liquid micellar casein concentrate. Each of the three volumes of liquid micellar casein concentrate were then diluted with soft water in order to obtain protein compositions of 3%, 6%, and 9%, respectively. The three diluted liquid micellar casein concentrate mixtures were then cooled to 4° C. In order to prepare the acid curd, volumes of a lactic acid solution were added to each volume of diluted liquid micellar casein concentrate mixture in order to reduce the pH of each diluted liquid micellar casein concentrate mixture to approximately 4.6 pH. As an alternative to lactic acid addition, the liquid micellar casein concentrate could be acidified with the use of lactic cultures similar to conventional cottage cheese production. Subsequently, each of the three containers were then tempered in a water bath in order to increase the temperature gradually, thereby increasing the firmness of the solutions (curd) within each of the three containers. During one test run, the curd within each of the three containers was tempered gradually for approximately 20-25 minutes. The curd was then cut, mixed gently, and heated to approximately 50° C. Following the tempering process to firm the curd, whey was drained from each of the three containers. The curd from each of the three containers was then filled into molds, and pressed to further drain the whey. Finally, the curd from each of the three containers (e.g., 3%, 6%, and 9% protein containers) were then vacuumed packaged and frozen.

In some embodiments, the volume of acid curd in step 220 may be prepared from a commercial concentrated milk protein source. In some embodiments, the acid curd may be produced from milk (e.g. skim milk).

In this test run, compositional and chemical analyses were also performed on each process cheese sample before using each of the ingredients in the process cheese formulations. Liquid micellar casein concentrate, micellar casein concentrate powder, and acid curd were analyzed to determine ash content (AOAC, 2000, method 945.46; 33.2.10), TS (AOAC, 2000; method 990.20; 33.2.44), total nitrogen TN (AOAC, 2000; method 991.20; 33.2.11).

In some embodiments, the method 200 includes step 230 of producing a volume of process cheese product by combining the volume of the concentrated milk protein with the volume of the acid curd, wherein a ratio of protein in the acid curd to the protein in the concentrated milk protein ranges from 1.32:1 to 3.20:1. For example, as shown in FIG. 1, a volume of micellar casein concentrate powder from the MCC tank 128 and a volume of acid curd from the acid curd tank 132 may be provided to a process cheese mixing unit 134. The process cheese mixing unit 134 may include any mixing unit known in the art for producing process cheese. In some embodiments, the volume of concentrated milk protein added to the volume of acid curd is a liquid. In some embodiments, the volume of concentrated milk protein added to the volume of acid curd is a powder.

In some embodiments, the concentrated milk protein (e.g., the micellar casein concentrate) is reduced in at least one of calcium or phosphorous. For example, the concentrated milk protein may be reduced in calcium. In another example, the concentrated milk protein may be reduced in phosphorous. In still another example, the concentrated milk protein may be reduced in both calcium and phosphorous.

In some embodiments, the process cheese produced from the method 200 may further include the step of adding an additional ingredient including, but not limited to, a rennet-curd cheese, a ripened cheese, a fresh cheese, a whey, a deproteinized whey, a butter, or a butter oil. For example, the process cheese from the method 200 may further include the addition of a cheddar cheese.

In one test run, three different formulas of process cheese were produced using the varying mixtures of acid curd (e.g., acid curd from the 3%, 6%, and 9% protein containers). The composition of ingredients used in making acid curd process cheese are provided in Table 1. The composition of ingredients used in making process cheese formulations is shown in Table 2. In tables having the term “composition” in the table legend, the measured substances of ash, water, total solids, salt, and lactose are determined as a percentage, whereas the measured substances of protein and total fat are determined as grams per 100 grams total material. Unless otherwise stated, the micellar casein concentrate was produced by South Dakota State University (SDSU) (e.g., micellar casein concentrates that have a commercial (e.g., comm.) label are not produced by SDSU).

TABLE 1

| Composition | Form. 1 | Form. 2 | Form. 3 | Form. 4 | Form. 5 | Form. 6 |
|---|---|---|---|---|---|---|
| Protein | 18.00 | 17.00 | 18.00 | 18.00 | 18.00 | 18.00 |
| Water | 49.00 | 50.00 | 46.00 | 46.00 | 46.00 | 46.00 |
| Total fat | 20.00 | 20.00 | 23.00 | 23.00 | 23.00 | 23.00 |
| Salt | 2.00 | 2.50 | 1.80 | 1.80 | 1.80 | 1.80 |
| Total solids | 50.57 | 50.00 | 54.00 | 54.00 | 54.00 | 54.00 |

TABLE 2

Composition (%)

| Treatment | TS | TN | Ash | pH |
|---|---|---|---|---|
| MCC liquid | 13.79 | 9.54 | 1.03 | 6.8 |
| MCC powder | 97.23 | 65.38 | 7.13 | |
| Acid curd-MCC 3% | 36.38 | 31.4 | 0.78 | 4.68 |
| Acid curd-MCC 6% | 43.17 | 37.82 | 1.07 | 4.54 |
| Acid curd-MCC 9% | 40 | 32.63 | 1.27 | 4 |
| Acid curd-Cottage cheese | 36.09 | 29.23 | | 4.92 |

Table 3 illustrates the composition of ingredients used in Formula 1 using liquid micellar casein protein with three different concentrations. As can be seen in Table 3, Formula 1 was prepared using 10% aged natural cheeses (cheddar), unsalted butter, acid curd (⅔ of the protein content; approximately 10 grams of protein), MCC powder (⅓ of the protein content; approximately 5 grams of protein), deproteinized whey, and salt. In a similar manner, Table 4 illustrates the composition of ingredients used in Formula 2 and Formula 3, and Table 5 illustrates the composition of ingredients used in Formula 4, Formula 5, and Formula 6. It is noted herein that all product cheese formulations were developed using Techwizard, an Excel-based formulation software program which is described in more detail by Metzger in NUTRITION LABELING USING A COMPUTER PROGRAM, Springer (2010), which is incorporated herein by reference in the entirety. The formulation software was conducted to balance the moisture, fat, protein, and salt compositions, as shown in Table 3, Table 4 and Table 5.

TABLE 3

| | 3% | 6% | 9% |
|---|---|---|---|
| Acid curd | 32.76 | 26.64 | 30.82 |
| Unsalted butter | 20.55 | 20.55 | 20.56 |
| Aged Cheddar cheese | 10.00 | 10.00 | 10.00 |
| Deproteinized whey | 6.44 | 6.65 | 5.79 |
| MCC powder | 7.76 | 7.75 | 7.80 |
| Salt | 2.00 | 2.00 | 2.00 |
| Water | 20.47 | 26.38 | 23.02 |

TABLE 4

| Ingredients | Formula 2 | Formula 3 |
|---|---|---|
| Acid curd from cottage cheese | 33.07 | 32.60 |
| Salted butter | 20.56 | 23.58 |
| Aged Cheddar cheese | 10.00 | 10.00 |
| Parmesan cheese | | 2.00 |
| Deproteinized whey | 6.22 | 6.70 |
| MCC liquid* | 25.01 | 19.52 |
| MCC powder* | 3.14 | 4.46 |
| Salt | 2.00 | 1.14 |

TABLE 5

| Ingredients | Formula 4 | Formula 5 | Formula 6 |
|---|---|---|---|
| Acid curd from cottage cheese | 31.58 | 31.41 | 31.41 |
| Salted butter | 22.21 | 22.10 | 22.11 |
| Aged Cheddar cheese | 15.00 | 15.00 | 15.00 |
| Deproteinized whey | 6.72 | 8.38 | 8.39 |
| MCC powder* | 7.04 | 5.61 | 5.61 |
| Salt | 1.17 | 1.17 | 1.17 |
| Water | 16.28 | 16.32 | 16.31 |

During one test run, approximately 300 grams of each formula was prepared to make process cheese. Process cheese formulations were prepared by mixing all ingredients in a KitchenAid mixer at room temperature for approximately thirty minutes to obtain a homogenous paste. An RVA paddle was inserted after the mixing was completed. Subsequently, approximately 25 grams of each homogenous paste mixture was placed into separate canisters (e.g., Formula 1 in Canister 1, Formula 2 in Canister 2, and the like). Each of the canisters were tempered at approximately 40° C. in warm water bath for 20-25 minutes.

After tempering, the canisters were held in the RVA for three minutes at approximately 95° C. The stirring speed was 1000 RPM during the first two minutes, and was subsequently decreased to 160 RPM during the last minute. The apparent viscosity or hot apparent viscosity of all the process cheese food samples (e.g., process cheese from Formula 1, process cheese from Formula 2, and the like) was measured by the end of cooking using the RVA as described by Prow in DEVELOPMENT OF A MELT TEST FOR PROCESS CHEESE SPREAD AND PROCESS CHEESE PRODUCT USING THE RAPID VISCO ANALYZER (RVA) (2004), which is incorporated herein by reference in the entirety.

Additionally, six copper cylinders with 20 mm diameter and 30 mm height were filled with the cooked process cheese samples for texture profile analysis (TPA). TPA analysis was performed using a TA.XT2 Texture Analyzer by Texture Technologies Corp., of Scarsdale N.Y. and Stable Microsystems, of Goldalming, UK, as described by Drake et. al. in RELATIONSHIP BETWEEN INSTRUMENTAL AND SENSORY MEASUREMENTS OF CHEESE TEXTURE, J. Texture Stud. 30:451-476 (1999), which is incorporated herein by reference in the entirety. Test conditions for TPA analysis included: uniaxial double bite compression, 50 mm diameter cylindrical flat probe (TA-25), compression (10%), and crosshead speed (1 mm/s). Additionally, process cheese samples were analyzed for TPA-hardness as described by Breene in APPLICATION OF TEXTURE PROFILE ANALYSIS TO INSTRUMENTAL FOOD TEXTURE EVALUATION, J. Texture Stud. 6:53-82 (1975), which is incorporated herein by reference in the entirety. As noted by Breene, TPA-hardness is a measure of un-melted texture of a cheese, which describes the firmness of the cheese. In addition to the six copper cylinders, six plastic molds with 28.3 mm diameter and 25 mm height were filled with the cooked process cheese samples for dynamic shear rheometer (DSR) analysis.

Dynamic rheological (DR) analysis was also used to analyze process cheese meltability using 25 mm parallel plate geometry. DR analysis was performed using a modified method, as described by Sutheerawattananonda and Bastian in MONITORING PROCESS CHEESE MELTABILITY USING DYNAMIC STRESS RHEOMETRY, J. Texture Stud. 29:169-183 (1998), which is incorporated herein by reference in the entirety. During DR analysis, process cheese samples were cut into approximately two mm thick slices using a wire cutter. A stress sweep test for the process cheese samples was performed at a frequency of 1.5 Hz, and a stress ranged from 1-1000 Pa at 20° C. using a rheometer with parallel plate geometry (Anton Paar GmhH, 8054 Graz, Austria). The stress sweep experiment determined that the maximum stress limit for the linear viscoelastic region was 50 Pa. The DR properties of the process cheese samples were then analyzed with a dynamic temperature ramp test. The ramp test was performed using the same rheometer at a range from 20−90° C. with a ramp rate of 1° C./min using a frequency of 1.5 Hz and a constant stress of 50 Pa (linear viscoelastic region). The temperature at which tan δ=1 (G″ G′) was used as the cheese melting point, and is referred to as the DSR melt temperature. Duplicate analyses were performed on each sample.

Furthermore, the meltability of each process cheese sample was measured using the modified Schreiber melt test, as described by Muthukumarappan et al., in MODIFIED SCHREIBER TEST FOR EVALUATION OF MOZZARELLA CHEESE MELTABILITY, 1 J. Diary Sci. 82:1068-1071 (1999), Kapoor et al., in EFFECT OF NATURAL CHEESE CHARACTERISTICS ON PROCESS CHEESE PROPERTIES, J. Diary Sci. 90:1625-1634 (2007), and Salunke in IMPACT OF TRANSGLUTAMINASE ON THE FUNCTIONALITY OF MILK PROTEIN CONCENTRATE AND MICELLAR CASEIN CONCENTRATE (2013), each of which are incorporated by reference in the entirety. Each of the process cheese samples were cut into cylinders of approximately 28.5 mm diameter and 7 mm height. Each cylinder was kept in Petri plates for ten minutes at room temperature. The plates were then transferred to a forced draft oven at 90° C. for seven minutes to melt the cylinders of process cheese samples. The plates with the melted cheese were then immediately cooled to room temperature. After cooling, the diameter of the melted cheese was measured using a Vernier caliper at four different locations for each sample, and the average was calculated for each process cheese sample. The meltability of each process cheese sample was reported as the area of the melted cheese in square millimeters (mm²).

The results of the various analyses and tests for the process cheese sample formed from Formula 1 is provided below in Table 6. As can be seen below, Table 6 provides mean values for viscosity (cP), TPA, DSR (melting point), Schreiber (melt diameter), moisture percentage, and pH of the process cheese produced with Formula 1. The moisture content of the 3%, 6%, and 9% process cheese was 48.54%, 48.09%, and 48.54%, respectively, while the pH values were 5.41, 5.44, and 5.37, respectively. The viscosity of the process cheese sample made from Formula 1 was 483.17 cP, 402.12 cP, and 474.93 cP for the 3%, 6%, and 9% process cheese, respectively. The hardness of the process cheese samples (TPA) was 383.72 g, 363.29 g, and 354.64 g, respectively. The melting temperatures were 51.31° C., 48.44° C., and 50.47° C., respectively, while the change in process cheese area after melting was 29.94 mm², 30.23 mm², and 31.38 mm², respectively.

TABLE 6

| | Parameters | | | | | |
|---|---|---|---|---|---|---|
| | RVA | | | | | |
| | viscosity | TPA | DSR | Schreiber | Moisture | |
| Treatment | (cP) | (g) | (° C.) | (mm) | (%) | pH |
| PC (3%) | 483.17 | 383.72 | 51.31 | 29.94 | 48.54 | 5.41 |
| PC (6%) | 402.12 | 363.29 | 48.44 | 30.23 | 48.09 | 5.44 |
| PC (9%) | 474.93 | 354.64 | 50.47 | 31.38 | 48.54 | 5.37 |

Similarly, the results of the various analyses and tests for the product cheese samples formed from Formulas 2-6 are provided below in Table 7A.

TABLE 7A

| | Parameters | | | | | |
|---|---|---|---|---|---|---|
| | RVA | | | | | |
| | viscosity | TPA | DSR | Schreiber | Moisture | |
| Treatment | (cP) | (g) | (° C.) | (mm) | (%) | pH |
| Formula 2 | 1091.8 | | | | 48.23 | 5.53 |
| Formula 3 | 1355.63 | 1008.19 | 57.82 | 31.63 | 42.43 | 5.44 |
| Formula 4 | 622.86 | 695.99 | 45.92 | 29.62 | 44.9 | 5.39 |
| Formula 5 | 281.9 | 651.22 | 42.88 | 30.97 | 44.87 | 5.41 |
| Formula 6 | 676.6 | 521.67 | 40.82 | 30.72 | 45.51 | 5.41 |

As may be seen above with reference to Tables 6-7A, there were no significant differences in the cooked viscosity, hardness, melting area, or melting temperature for process cheeses produced using different acid curd compositions (e.g., 3%, 6%, and 9% protein composition acid curd). Furthermore, the process cheeses produced according to embodiments of the present disclosure exhibited similar characteristics to process cheeses produced according to traditional approaches with the use of emulsifying salts. Accordingly, it is contemplated herein that process cheese produced with approximately a 2:1 ratio of protein from acid curd relative to protein from concentrated milk protein (e.g., micellar casein) may exhibit characteristics which are substantially similar to process cheeses produced with emulsifying salts.

Table 7B describes a typical process cheese product formulation that uses the emulsifying salt disodium phosphate. The composition of the formulation is 49% moisture, 20% fat, 18% protein, and 2% salt.

TABLE 7B

| Ingredient | Percentage (%) |
|---|---|
| Disodium Phosphate | 2.50 |
| Cheddar cheese | 60.10 |
| Milk/whey permeate | 7.20 |
| Milk Protein concentrate | 3.40 |
| Salt | 1.00 |
| Water | 25.80 |
| Total | |

Depending on the age (21-120 days) of the cheese used in the formulation the functional properties of the cheese will range from 300-700 cP cooked viscosity, 100-400 g hardness, 45-60° C. melt temperature and 28-38 mm melt diameter. The functional properties of the developed formulations without emulsifying salts are within this range.

In this disclosure, for the production of process cheese without the use of emulsifying salt, the ideal ratio of acid curd protein to concentrated milk protein (e.g., in the form of micellar casein concentrate protein) is 2:1 (e.g., 67% of the protein from acid curd and 33% of the protein from micellar casein concentrate). The amount of acid curd and concentrated milk protein needed in a formulation can be calculated using the amount of protein in the formulation from the acid curd and the concentrated milk protein as well as the protein content of the acid curd and the micellar casein

If the ratio of protein from the acid curd to protein from the concentrated milk protein is significantly altered, the functionality of the process cheese will be altered and an emulsion will not be created during the cooking process and curd particles and free oil will be present at the end of the cooking step. For instance, in the previous example, if the amount of protein from acid is increased from 10 g of protein to 11.5 g and the amount of protein from micellar casein concentrate is decreased from 5 g of protein to 3.5 g, the ratio of acid curd protein to micellar casein concentrate would increase to 3.29:1 (e.g., 76.7% of the protein from acid curd and 23.3% of the protein from micellar casein), and the formulation will not form an emulsion during the cooking process. Conversely, if the amount of protein from acid curd is decreased from 10 g of protein to 8.5 g and the amount of protein from micellar casein concentrate is increased from 5 g of protein to 6.5 g the ratio of acid curd protein:micellar casein protein would decrease to 1.31:1 (e.g., 56.7% of the protein from acid curd and 43.2% of the protein from micellar casein) and the formulation will not form an emulsion during the cooking process.

The results of the various analyses and tests performed on various process cheese samples is further shown and described with reference to Tables 8-36. In tables having the term “composition” in the table legend, the measured substances of ash, water, total solids (TS), salt, and lactose are determined as a percentage, whereas the measured substances of protein and total fat are determined as grams per 100 grams total material.

Tables 8-11 refer to a process cheese formula utilizing a cheddar cheese and a skim cheese curd.

TABLE 8

| Ingredient | Amount (g) |
|---|---|
| Curd (Skim) | 102.63 |
| MCC liquid | 68.96 |
| Butter (salted) | 61.67 |
| Cheese, Cheddar | 30.00 |
| MCC powder | 13.45 |
| Deproteinized whey | 17.27 |
| Salt | 6.00 |

TABLE 9

| | | |
|---|---|---|
| Ingredient | Percentage (%) | Composition |

| | | | |
|---|---|---|---|
| Curd (Skim) | 34.21 | Ash | 3.92 |
| MCC liquid | 22.21 | Protein | 18 |
| Butter (salted) | 20.55 | Water | 49 |
| Cheese, Cheddar | 10 | Total Fat | 20 |
| MCC powder | 4.48 | Total Solids | 51 |
| Deproteinized whey | 5.75 | Salt | 2 |
| Salt | 2 | Lactose | 4.58 |
| Total | 100 | | |

TABLE 10

| | | | | Total | Total | | |
|---|---|---|---|---|---|---|---|
| Ingredient | Ash | Protein | Water | Fat | Solids | Salt | Lactose |
| Curd (Skim) | 0 | 29.23 | 63.91 | 0 | 36.09 | 0 | 0 |
| MCC liquid | 1.25 | 9.55 | 86.2 | 0 | 13.8 | 0 | 0 |
| Butter (salted) | 2.11 | 0.85 | 15.87 | 81.11 | 84.13 | 0 | 0.1 |
| Cheese, cheddar | 3.93 | 24.9 | 36.75 | 33.14 | 63.25 | 0 | 0.7 |
| MCC powder | 7.13 | 65.4 | 2.77 | 0 | 97.23 | 0 | 0 |
| Deproteinized whey | 8.4 | 3.6 | 4.5 | 0.2 | 95.5 | 0 | 78 |
| Salt | 100 | 0 | 0 | 0 | 100 | 100 | 0 |

TABLE 11

| | | | | | Total | Total | | |
|---|---|---|---|---|---|---|---|---|
| Ingredient | % (wt/wt) | Ash | Protein | Water | Fat | Solids | Salt | Lactose |
| Curd (Skim) | 34.21 | 0 | 9.99 | 20.63 | 0 | 12.34 | 0 | 0 |
| MCC liquid | 22.98 | 0.28 | 2.19 | 19.81 | 0 | 3.17 | 0 | 0 |
| Butter (salted) | 20.55 | 0.43 | 0.17 | 3.26 | 16.67 | 17.29 | 0 | 0 |
| Cheese, cheddar | 10 | 0.39 | 2.49 | 3.67 | 3.31 | 6.32 | 0 | 0 |
| MCC powder | 4.48 | 0.31 | 2.93 | 0.12 | 0 | 4.36 | 0 | 0 |
| Deproteinized whey | 5.75 | 0.48 | 0.20 | 0.25 | 0.01 | 5.50 | 0 | 0 |
| Salt | 2 | 2 | 0 | 0 | 0 | 2 | 2 | 2 |
| Total | 100 | 3.91 | 18 | 49 | 20 | 51 | 2 | 2 |

Tables 12-15 refer to a process cheese formula utilizing a cheddar cheese, and acid curd and a parmesan cheese.

TABLE 12

| | | |
|---|---|---|
| Ingredient | Percentage (%) | Composition (%) |

| | | | |
|---|---|---|---|
| Acid Curd | 32.6 | Ash | 3.28 |
| MCC liquid | 23.58 | Protein | 18 |
| Butter (salted) | 19.51 | Water | 46 |
| Cheese, Cheddar | 10 | Total Fat | 23 |
| Deproteinized whey | 4.46 | Total Solids | 54 |
| MCC Powder | 2 | Salt | 1.8 |
| Salt | 1.13 | Lactose | 5.32 |
| Total | 100 | | |

TABLE 13

| | | | | Total | Total | | |
|---|---|---|---|---|---|---|---|
| Ingredient | Ash | Protein | Water | Fat | Solids | Salt | Lactose |
| Acid Curd | 0 | 29.23 | 63.91 | 0 | 36.09 | 0 | 0 |
| Butter (salted) | 2.11 | 0.85 | 15.87 | 81.11 | 84.13 | 1.72 | 0.1 |
| MCC liquid | 1.25 | 9.55 | 86.2 | 0 | 13.8 | 0 | 0 |
| Cheese, cheddar | 3.93 | 24.9 | 36.75 | 33.14 | 63.25 | 1.66 | 0.7 |
| Deproteinized whey | 8.4 | 3.6 | 4.5 | 0.2 | 95.5 | 0 | 78 |
| MCC Powder | 7.13 | 65.4 | 2.77 | 0 | 97.23 | 0 | 0 |
| Cheese, Parmesan, shredded | 6.39 | 37.86 | 25 | 27.34 | 75 | 4.53 | 0 |
| Salt | 100 | 0 | 0 | 0 | 100 | 100 | 0 |

TABLE 14

| | | | | | Total | Total | | |
|---|---|---|---|---|---|---|---|---|
| Ingredient | % (wt/wt) | Ash | Protein | Water | Fat | Solids | Salt | Lactose |
| Acid Curd | 32.6 | 0 | 9.52 | 20.83 | 0 | 11.76 | 0 | 0 |
| Butter (salted) | 23.58 | 0.49 | 0.20 | 3.74 | 19.12 | 19.83 | 0.40 | 0.02 |
| MCC Liquid | 19.51 | 0.24 | 1.86 | 16.82 | 0 | 2.69 | 0 | 0 |
| Cheese, cheddar | 10 | 0.39 | 2.49 | 3.67 | 3.31 | 6.32 | 0.16 | 0.07 |
| Deproteinized Whey | 6.70 | 0.56 | 0.24 | 0.30 | 0.01 | 6.40 | 0 | 5.22 |
| MCC Powder | 4.46 | 0.31 | 2.91 | 0.12 | 0 | 4.33 | 0 | 0 |
| Cheese, Parm. Shred. | 2 | 0.12 | 0.75 | 0.5 | 0.54 | 1.5 | 0.09 | 0 |
| Salt | 1.13 | 1.378 | 0 | 0 | 0 | 1.13 | 1.13 | 0 |
| Total | 100 | 3.28 | 18 | 46 | 23 | 54 | 1.8 | 5.32 |

TABLE 15

| Ingredient | Amount (g) |
|---|---|
| Acid Curd | 326.00 |
| Butter (salted) | 235.80 |
| MCC Liquid | 195.16 |
| Cheese, Cheddar | 100.00 |
| Deproteinized whey | 67.03 |
| MCC Powder | 44.62 |
| Cheese, Parmesan, Shredded | 20.00 |
| Salt | 11.37 |

Tables 16-19 refer to a process cheese formula utilizing a cheddar cheese (25% wt/wt) and an acid curd.

TABLE 16

| | | |
|---|---|---|
| Ingredient | Percentage (%) | Composition (%) |

| | | | |
|---|---|---|---|
| Acid Curd | 25.87 | Ash | 3.46 |
| Butter (salted) | 18.12 | Protein | 18 |
| Cheese, Cheddar | 25 | Water | 46 |
| Deproteinized whey | 7.20 | Total Fat | 23 |
| MCC Powder | 5.81 | Total Solids | 54 |
| Salt | 1.07 | Salt | 1.8 |
| Water | 16.91 | Lactose | 5.81 |
| Total | 100 | | |

TABLE 17

| | | | | Total | Total | | |
|---|---|---|---|---|---|---|---|
| Ingredient | Ash | Protein | Water | Fat | Solids | Salt | Lactose |
| Acid Curd | 0 | 29.23 | 63.91 | 0 | 36.09 | 0 | 0 |
| Butter (salted) | 2.11 | 0.85 | 15.87 | 81.11 | 84.13 | 1.72 | 0.1 |
| Cheese, cheddar | 3.93 | 24.9 | 36.75 | 33.14 | 63.25 | 1.66 | 0.7 |
| Deproteinized whey | 8.4 | 3.6 | 4.5 | 0.2 | 95.5 | 0 | 78 |
| MCC Powder | 7.13 | 65.4 | 2.77 | 0 | 97.23 | 0 | 0 |
| Salt | 100 | 0 | 0 | 0 | 100 | 100 | 0 |
| Water | 0 | 0 | 100 | 0 | 0 | 0 | 0 |

TABLE 18

| | | | | | Total | Total | | |
|---|---|---|---|---|---|---|---|---|
| Ingredient | % (wt/wt) | Ash | Protein | Water | Fat | Solids | Salt | Lactose |
| Acid Curd | 25.87 | 0 | 7.56 | 16.53 | 0 | 9.33 | 0 | 0 |
| Butter (salted) | 18.12 | 0.38 | 0.15 | 2.87 | 14.70 | 15.24 | 0.31 | 0.01 |
| Cheese, cheddar | 25 | 0.98 | 6.22 | 9.18 | 8.28 | 15.81 | 0.41 | 0.17 |
| Deproteinized powder | 7.20 | 0.60 | 0.25 | 0.32 | 0.01 | 6.88 | 0 | 5.61 |
| MCC Powder | 5.81 | 0.41 | 3.79 | 0.16 | 0 | 5.64 | 0 | 0 |
| Salt | 1.07 | 1.07 | 0 | 0 | 0 | 1.07 | 1.07 | 0 |
| Water | 16.91 | 0 | 0 | 16.91 | 0 | 0 | 0 | 0 |
| Total | 100 | 3.45 | 18 | 46 | 23 | 54 | 1.8 | 5.81 |

TABLE 19

| Ingredient | Amount (g) | |
|---|---|---|
| Acid Curd | 77.61 | g |
| Butter (salted) | 54.37 | g |
| Cheese, Cheddar | 75.00 | g |
| Deproteinized whey | 21.61 | g |
| MCC powder | 17.43 | g |
| Salt | 3.22 | g |
| Water | 50.75 | g |

Tables 21-24 refer to a process cheese formula utilizing a cheddar cheese (15% wt/wt), and an acid curd with a commercial MCC power manufactured by Milk Specialties Global (MSG) substituted in for the proprietary MCC powder. The ratio of protein from the cheeses to the protein of the MCC is 2:1.

TABLE 20

| | | |
|---|---|---|
| Ingredient | Percentage (%) | Composition |

| | | | |
|---|---|---|---|
| Acid Curd | 31.40 | Ash | 3.46 |
| Butter (salted) | 22.11 | Protein | 18 |
| Cheese, Cheddar | 15 | Water | 46 |
| Deproteinized whey | 8.39 | Total Fat | 23 |
| MCC powder comm. | | Total Solids | 54 |
| Salt | 1.17 | Salt | 1.8 |
| Water | 16.30 | Lactose | 6.67 |
| Total | 100 | | |

TABLE 21

| | | | | Total | Total | | |
|---|---|---|---|---|---|---|---|
| Ingredient | Ash | Protein | Water | Fat | Solids | Salt | Lactose |
| Acid Curd | 0 | 29.23 | 63.91 | 0 | 36.09 | 0 | 0 |
| Butter (salted) | 2.11 | 0.85 | 15.87 | 81.11 | 84.13 | 1.72 | 0.1 |
| Cheese, cheddar | 3.93 | 24.9 | 36.75 | 33.14 | 63.25 | 1.66 | 0.7 |
| Deproteinized whey | 8.4 | 3.6 | 4.5 | 0.2 | 95.5 | 0 | 78 |
| MCC powder comm./MSG | 6.8 | 81.9 | 3.9 | 1.4 | 96.1 | 0 | 0 |
| Salt | 100 | 0 | 0 | 0 | 100 | 100 | 0 |
| Water | 0 | 0 | 100 | 0 | 0 | 0 | 0 |

TABLE 22

| | | | | | Total | Total | | |
|---|---|---|---|---|---|---|---|---|
| Ingredient | % (wt/wt) | Ash | Protein | Water | Fat | Solids | Salt | Lactose |
| Acid Curd | 31.41 | 0.00 | 9.18 | 20.07 | 0.00 | 11.33 | 0.00 | 0.00 |
| Butter (salted) | 22.11 | 0.47 | 0.19 | 3.51 | 17.93 | 18.60 | 0.38 | 0.02 |
| Cheese, cheddar | 15.00 | 0.59 | 3.74 | 5.51 | 4.97 | 9.49 | 0.25 | 0.11 |
| Deproteinized Whey | 8.39 | 0.70 | 0.30 | 0.38 | 0.02 | 8.01 | 0.00 | 6.55 |
| MCC powder comm./MSG | 5.61 | 0.38 | 4.59 | 0.22 | 0.08 | 5.39 | 0.00 | 0.00 |
| Salt | 1.17 | 1.17 | 0.00 | 0.00 | 0.00 | 1.17 | 1.17 | 0.00 |
| Water | 16.31 | 0.00 | 0.00 | 16.31 | 0.00 | 0.00 | 0.00 | 0.00 |
| Total | 100.00 | 3.31 | 18.00 | 46.00 | 23.00 | 54.00 | 1.80 | 6.67 |

TABLE 23

| Ingredient | Amount (g) |
|---|---|
| Acid Curd | 77.61 |
| Butter (salted) | 54.37 |
| Cheese, Cheddar | 75 |
| Deproteinized whey | 21.61 |
| MCC powder Comm./MSG | 17.43 |
| Salt | 3.22 |
| Water | 50.75 |

Table 25 lists the moisture content, total solid (TS) content, and casein nitrogen (TN) percentage for two lots (Vat-1 and Vat-2) of cottage cheese curds.

TABLE 24

| Sample | Run | % Moisture | % TS | Ave. % TS | % TN | Ave. % TN |
|---|---|---|---|---|---|---|
| Vat-1 | 1 | 81.44 | 18.56 | 18.58 | 17.60 | 17.44 |
| | 2 | 81.30 | 18.70 | | 17.28 | |
| | 3 | 81.69 | 18.31 | | | |
| | 4 | 81.27 | 18.73 | | | |
| Vat-2 | 1 | 80.36 | 19.64 | 19.90 | 17.89 | 17.67 |
| | 2 | 80.38 | 19.62 | | 17.44 | |
| | 3 | 79.37 | 20.63 | | | |
| | 4 | 80.29 | 19.71 | | | |

Tables 26-29 refer to a process cheese formula using a cheddar cheese (15% wt/wt) and an acid cheese curd (cottage, Vat-2) with a commercial MCC power substituted in for the proprietary MCC powder and an anhydrous butter oil substituted in for salted butter. The ratio of protein from the acid curd to the protein of the MCC is 2:1.

TABLE 25

| Ingredient | Percentage (%) | Composition | |
|---|---|---|---|
| Acid Curd Vat-2 | 49.72 | Ash | 2.85 |
| Cheese, Cheddar | 15 | Protein | 17 |
| MCC powder comm./MSG | 5.25 | Water | 48 |
| Salt | 1.55 | Total Fat | 27 |
| Water | 2.20 | Total Solids | 52 |
| Deproteinized whey | 4.20 | Salt | 1.8 |
| Butter oil anh. | 22.06 | Lactose | 3.38 |
| Total | 100 | | |

TABLE 26

| | | | | Total | Total | | |
|---|---|---|---|---|---|---|---|
| Ingredient | Ash | Protein | Water | Fat | Solids | Salt | Lactose |
| Acid Curd-Cottage Vat-2 | 0 | 17.6 | 80.1 | 0 | 19.9 | 0 | 0 |
| Cheese, cheddar | 3.93 | 24.9 | 36.75 | 33.14 | 63.25 | 1.66 | 0.7 |
| MCC powder Comm./MSG | 6.8 | 81.9 | 3.9 | 1.4 | 96.1 | 0 | 0 |
| Salt | 100 | 0 | 0 | 0 | 100 | 100 | 0 |
| Water | 0 | 0 | 100 | 0 | 0 | 0 | 0 |
| Deproteinized whey | 8.4 | 3.6 | 4.5 | 0.2 | 95.5 | 0 | 78 |
| Butter oil anh. | 0 | 0.28 | 0.24 | 99.48 | 99.76 | 0 | 0 |

TABLE 27

| | | | | | Total | Total | | |
|---|---|---|---|---|---|---|---|---|
| Ingredient | % (wt/wt) | Ash | Protein | Water | Fat | Solids | Salt | Lactose |
| Acid Curd-Cottage Vat-2 | 49.73 | 0.00 | 8.75 | 39.83 | 0.00 | 9.90 | 0.00 | 0.00 |
| Cheese, cheddar | 15.00 | 0.59 | 3.74 | 5.51 | 4.97 | 9.49 | 0.25 | 0.11 |
| MCC powder Comm./MSG | 5.25 | 0.36 | 4.30 | 0.20 | 0.07 | 5.05 | 0.00 | 0.00 |
| Salt | 1.55 | 1.55 | 0.00 | 0.00 | 0.00 | 1.55 | 1.55 | 0.00 |
| Water | 2.21 | 0.00 | 0.00 | 2.21 | 0.00 | 0.00 | 0.00 | 0.00 |
| Deproteinized whey | 4.20 | 0.35 | 0.15 | 0.19 | 0.01 | 4.01 | 0.00 | 3.28 |
| Butter oil anh. | 22.06 | 0.00 | 0.06 | 0.05 | 21.95 | 22.01 | 0.00 | 0.00 |
| Total | 100.00 | 2.85 | 17.00 | 48.00 | 27.00 | 52.00 | 1.80 | 3.38 |

TABLE 28

| Ingredient | Amount (g) |
|---|---|
| Acid Curd-Cottage Vat-2 | 99.45 |
| Cheese, Cheddar | 30 |
| MCC powder | 10.5 |
| Salt | 3.10 |
| Water | 4.41 |
| Butter (salted) | 8.40 |
| Deproteinized whey | 44.12 |

Tables 30-33 refer to a process cheese formula using a cheddar cheese (15% wt/wt) and an acid cheese curd (cottage, Vat-2) with a commercial MCC power substituted in for the proprietary MCC powder. The ratio of protein from the acid curd to the protein of the MCC is 2:1.

TABLE 29

| Ingredient | Percentage (%) | Composition | |
|---|---|---|---|
| Acid Curd Cottage Vat-2 | 49.08 | Ash | 2.85 |
| Cheese, Cheddar | 15.00 | Protein | 17 |
| MCC powder | 5.25 | Water | 50 |
| Salt | 1.11 | Total Fat | 26 |
| Water | 0.74 | Total Solids | 50 |
| Butter (salted) | 25.83 | Salt | 1.8 |
| Deproteinized whey | 3.00 | Lactose | 2.47 |
| Total | 100.00 | | |

TABLE 30

| | | | | Total | Total | | |
|---|---|---|---|---|---|---|---|
| Ingredient | Ash | Protein | Water | Fat | Solids | Salt | Lactose |
| Acid Curd-Cottage Vat-2 | 0 | 17.6 | 80.1 | 0 | 19.9 | 0 | 0 |
| Cheese, cheddar | 3.93 | 24.9 | 36.75 | 33.14 | 63.25 | 1.66 | 0.7 |
| MCC powder Comm./MSG | 6.8 | 81.9 | 3.9 | 1.4 | 96.1 | 0 | 0 |
| Salt | 100 | 0 | 0 | 0 | 100 | 100 | 0 |
| Water | 0 | 0 | 100 | 0 | 0 | 0 | 0 |
| Butter (salted) | 2.11 | 0.85 | 15.87 | 81.11 | 84.13 | 1.72 | 0.1 |
| Deproteinized whey | 8.4 | 3.6 | 4.5 | 0.2 | 95.5 | 0 | 78 |

TABLE 31

| | | | | | Total | Total | | |
|---|---|---|---|---|---|---|---|---|
| Ingredient | % (wt/wt) | Ash | Protein | Water | Fat | Solids | Salt | Lactose |
| Acid Curd-Cottage Vat-2 | 49.08 | 0.00 | 8.64 | 39.31 | 0.00 | 9.77 | 0.00 | 0.00 |
| Cheese, cheddar | 15.00 | 0.59 | 3.74 | 5.51 | 4.97 | 9.49 | 0.25 | 0.11 |
| MCC powder Comm./MSG | 5.25 | 0.36 | 4.30 | 0.20 | 0.07 | 5.05 | 0.00 | 0.00 |
| Salt | 1.11 | 1.11 | 0.00 | 0.00 | 0.00 | 1.11 | 1.11 | 0.00 |
| Water | 0.74 | 0.00 | 0.00 | 0.74 | 0.00 | 0.00 | 0.00 | 0.00 |
| Butter (salted) | 25.83 | 0.55 | 0.22 | 4.10 | 20.95 | 21.73 | 0.44 | 0.03 |
| Deproteinized whey | 3.00 | 0.25 | 0.11 | 0.14 | 0.01 | 2.86 | 0.00 | 2.34 |
| Total | 100.00 | 2.58 | 17.00 | 50.00 | 26.00 | 50.00 | 1.90 | 2.47 |

TABLE 32

| Ingredient | Amount (g) |
|---|---|
| Acid Curd-Cottage Vat-2 | 147.23 |
| Cheese, Cheddar | 45.00 |
| MCC powder comm./MSG | 15.75 |
| Salt | 3.32 |
| Water | 2.21 |
| Butter (salted | 77.48 |
| Deproteinized whey | 8.99 |

Tables 34-37 refer to a process cheese formula using a cheddar cheese (15% wt/wt) and an acid cheese curd (cottage, Vat-2) with a commercial MCC powder substituted in for the proprietary MCC powder and an anhydrous butter oil substituted in for salted butter, with no water added. The ratio of protein from the acid curd to the protein of the MCC is 2:1.

TABLE 33

| Ingredient | Percentage (%) | Composition | |
|---|---|---|---|
| Acid Curd-Cottage Vat-2 | 52.97 | Ash | 2.97 |
| Cheese, Cheddar | 10.91 | Protein | 17 |
| Deproteinized Whey | 6.40 | Water | 47 |
| MCC powder comm./MSG | 5.70 | Total Fat | 26 |
| Salt | 1.62 | Total Solids | 53 |
| Butter oil anh. | 22.41 | Salt | 1.8 |
| Total | 100.00 | Lactose | 5.07 |

TABLE 34

| | | | | Total | Total | | |
|---|---|---|---|---|---|---|---|
| Ingredient | Ash | Protein | Water | Fat | Solids | Salt | Lactose |
| Acid Curd-Cottage Vat-2 | 0 | 17.6 | 80.1 | 0 | 19.9 | 0 | 0 |
| Cheese, cheddar | 3.93 | 24.9 | 36.75 | 33.14 | 63.25 | 1.66 | 0.7 |
| Deproteinized whey | 8.4 | 3.6 | 4.5 | 0.2 | 95.5 | 0 | 78 |
| MCC powder Comm./MSG | 6.8 | 81.9 | 3.9 | 1.4 | 96.1 | 0 | 0 |
| Salt | 100 | 0 | 0 | 0 | 100 | 100 | 0 |
| Butter oil anh. | 0 | 0.28 | 0.24 | 99.48 | 99.76 | 0 | 0 |

TABLE 35

| | | | | | Total | Total | | |
|---|---|---|---|---|---|---|---|---|
| Ingredient | % (wt/wt) | Ash | Protein | Water | Fat | Solids | Salt | Lactose |
| Acid Curd-Cottage Vat-2 | 52.97 | 0.00 | 9.32 | 42.43 | 0.00 | 10.54 | 0.00 | 0.00 |
| Cheese, cheddar | 10.91 | 0.43 | 2.72 | 4.01 | 3.62 | 6.90 | 0.18 | 0.08 |
| Deproteinized whey | 6.40 | 0.54 | 0.23 | 0.29 | 0.01 | 6.11 | 0.00 | 4.99 |
| MCC powder comm./MSG | 5.70 | 0.39 | 4.67 | 0.22 | 0.08 | 5.48 | 0.00 | 0.00 |
| Salt | 1.62 | 1.62 | 0.00 | 0.00 | 0.00 | 1.62 | 1.62 | 0.00 |
| Butter oil (anhydrous) | 22.41 | 0.00 | 0.06 | 0.05 | 22.29 | 22.35 | 0.00 | 0.00 |
| Total | 100.00 | 2.97 | 17.00 | 47.00 | 26.00 | 53.00 | 1.80 | 5.07 |

TABLE 36

| Ingredient | Amount (g) |
|---|---|
| Acid Curd-Cottage Vat-2 | 158.90 |
| Cheese, Cheddar | 32.72 |
| Deproteinized whey | 19.18 |
| MCC powder comm./MSG | 17.1 |
| Salt | 4.85 |
| Butter oil anh. | 67.22 |

Consumers often want to reduce salt in their diets, and will look at food labeling to ensure that their food items do not contain a high amount of salt. Process cheese commonly uses emulsifying salt during its manufacture, where it may be ultimately listed on process cheese ingredient labels and negatively perceived by the customer. By creating a process cheese through the combination of acid curd and concentrated milk protein without the addition of emulsifying salt, a process cheese with a clean label may be produced.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

The previous description is presented to enable one of ordinary skill in the art to make and use the invention as provided in the context of a particular application and its requirements. Various modifications to the described embodiments will be apparent to those with skill in the art, and the general principles defined herein may be applied to other embodiments. Additionally, phrases that disclose the addition of one component to another component are not limiting to the sequence or placement of one component to another component. For example, the addition of component A to component B may have the same meaning as the addition of component B to component A (e.g., the two components are mixed together). Therefore, the present invention is not intended to be limited to the particular embodiments shown and described, but is to be accorded the widest scope consistent with the principles and novel features herein disclosed.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

It is further contemplated that each of the embodiments of the method described above may include any other step(s) of any other method(s) described herein. In addition, each of the embodiments of the method described above may be performed by any of the systems described herein.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed:

1. A process cheese comprising:
an acid curd; and
a concentrated milk protein, wherein a ratio of protein in the acid curd to the protein in the concentrated milk protein ranges from 1.35:1 to 3.35:1.

2. The process cheese of claim 1, wherein the concentrated milk protein comprises a milk protein concentrate.

3. The process cheese of claim 1, wherein the concentrated milk protein comprises a micellar casein.

4. The process cheese of claim 1, wherein the process cheese is produced without an emulsifying salt.

5. The process cheese of claim 1, wherein the ratio of protein in the acid curd to the protein in the concentrated milk protein ranges from 1.40:1 to 3.0:1.

6. The process cheese of claim 1, wherein the ratio of protein in the acid curd to the protein in the concentrated milk protein ranges from 1.45:1 to 2.75:1.

7. The process cheese of claim 1, wherein the ratio of protein in the acid curd to the protein in the concentrated milk protein ranges from 1.5:1 to 2.5:1.

8. The process cheese of claim 5, wherein the ratio of protein in the acid curd to the protein in the concentrated milk protein ranges from 1.75:1 to 2.25:1.

9. The process cheese of claim 6, wherein the ratio of protein in the acid curd to the protein in the concentrated milk protein is approximately 2:1.

10. The process cheese of claim 1, wherein the acid curd is produced from the concentrated milk protein.

11. The process cheese of claim 1, wherein the acid curd is produced from at least one of a commercial concentrated milk protein, or a milk.

12. The process cheese of claim 1, wherein the concentrated milk protein is reduced in at least one of calcium or phosphorous.

13. The process cheese of claim 1, wherein the concentrated milk protein comprises at least one of a liquid concentrated milk protein or a concentrated milk protein powder.

14. The process cheese of claim 1, further comprising at least one of a rennet-curd cheese, a ripened cheese, a fresh cheese, a whey, a non-emulsifying salt, a deproteinized whey, a butter, or a butter oil.

15. A method of producing process cheese comprising:
preparing a volume of concentrated milk protein;
preparing a volume of acid curd; and
producing a volume of process cheese product by combining the volume of the concentrated milk protein with the volume of the acid curd, wherein a ratio of protein in the acid curd to the protein in the concentrated milk protein ranges from 1.35:1 to 3.35:1.

16. The process cheese of claim 15, wherein the concentrated milk protein comprises a milk protein concentrate.

17. The process cheese of claim 15, wherein the concentrated milk protein comprises a micellar casein.

18. The method of producing process cheese of claim 15, wherein the process cheese is produced without an emulsifying salt.

19. The method of producing process cheese of claim 15, wherein the ratio of protein in the acid curd to the protein in the concentrated milk protein ranges from 1.40:1 to 3.0:1.

20. The method of producing process cheese of claim 19, wherein the ratio of protein in the acid curd to the protein in the concentrated milk protein ranges from 1.45:1 to 2.75:1.

21. The method of producing process cheese of claim 20, wherein the ratio of protein in the acid curd to the protein in the concentrated milk protein ranges from 1.5:1 to 2.5:1.

22. The method of producing process cheese of claim 21, wherein the ratio of protein in the acid curd to the protein in the concentrated milk protein ranges from 1.75:1 to 2.25:1.

23. The method of producing process cheese of claim 22, wherein the ratio of protein in the acid curd to the protein in the concentrated milk protein is approximately 2:1.

24. The method of producing process cheese of claim 15, wherein the acid curd is produced from the concentrated milk protein.

25. The method of producing process cheese of claim 15, wherein the acid curd is produced from at least one of a commercial concentrated milk protein, or a milk.

26. The method of producing process cheese of claim 15, wherein the concentrated milk protein is reduced in at least one of calcium or phosphorous.

27. The method of producing process cheese of claim 15, wherein the volume of concentrated milk protein is at least one of a liquid concentrated milk protein or a concentrated milk protein powder.

28. The method of producing process cheese of claim 15, further comprising the step of adding at least one of a rennet-curd cheese, a ripened cheese, a fresh cheese, a whey, a non-emulsifying salt, a deproteinized whey, a butter, or a butter oil.

29. A process cheese prepared by a process comprising the steps of:
preparing a volume of an acid curd;
preparing a volume of a concentrated milk protein;
producing a volume of process cheese product by combining the volume of the concentrated milk protein with the volume of the acid curd, wherein a ratio of protein in the acid curd to protein in the concentrated milk protein ranges from 1.35:1 to 3.35:1.
